(19) United States
(12) Patent Application Publication
(10) Pub. No.: US 2005/0092556 A1
(43) Pub. Date: May 5, 2005

(54) Arrangement for monitoring the temperature of elevator brakes

(76) Inventor: Wolfgang Michael Schoppa, Oberkramer (DE)

Correspondence Address: OTIS ELEVATOR COMPANY;INTELLECTUAL PROPERTY DEPARTMENT, 10 FARM SPRINGS, FARMINGTON, CT, 06032, US

(21) Appl. No.: 10/504,833

(22) PCT Filed: Feb. 18, 2003
(86) PCT No.: PCT/US03/04806

(30) Foreign Application Priority Data
Feb. 18, 2002 (DE) 10206746.5

(51) Int. Cl. F16D 66/00

(52) U.S. Cl. 188/1.11 R

(57) ABSTRACT

Elevator brake (2) with a brake shoe (4, 6) and a brake lining (10, 12) attached thereto, at least one brake lining temperature sensor (10, 12) arranged in the brake shoe (4, 6), at least one ambient temperature sensor (22), and a brake monitoring circuit (14) that is connected to and receives information from the temperature sensors (10, 12, 22), characterized by the fact that the brake lining temperature sensor (10, 12) has a generally cylindrical shape and a temperature-sensitive front end, by the fact that the brake lining temperature sensor (10, 12) is arranged in a through hole (28) in the brake shoe (4, 6) in such a way that its temperature-sensitive front end is generally 7 level with the contact surface (26) between the brake shoe (4, 6) and the brake lining (10, 12), and by the fact that the brake lining temperature sensor (10, 12) is insulated from the inner wall of the through hole (28).

The present invention pertains to an elevator brake with at least one brake shoe and a brake lining fixed thereon, at least one brake lining temperature sensor arranged in the brake lining, at least one ambient temperature sensor, and a brake monitoring circuit that is connected to and receives information from the temperature sensors. The invention also pertains to a method for retrofitting an elevator system with such a brake monitoring arrangement.

Elevator systems basically contain elevator brakes that are arranged in the drive unit, for example, in a spatial vicinity of the driving pulley. These elevator brakes are typically designed in the form of external shoe brakes that act upon a brake drum. The brake shoes are usually spring-loaded into the engaged position, and contain an electromagnetic actuating element for opening the brake in an electrically controlled fashion. These brakes typically serve to hold the cabin at a landing while the motor is at a standstill. When switched off, electric motors do not generate a braking moment such that, when the cabin is at a standstill at a landing, the cabin would move above or below the stopping point depending on the load status if no brake were provided. In older systems, the brake engages shortly before the cabin comes to a standstill, when the cabin has been decelerated to a certain speed by the elevator motor, and the elevator motor was subsequently switched off. In newer systems, the elevator control decelerates the driving motor until it comes to a standstill, with the brake engaging only when the cabin is no longer in motion. In addition, the brake is usually also engaged during so-called inspection runs. Such inspection runs are usually performed when the elevator system is initially calibrated or during retrofitting procedures. One person usually rides on the roof of the elevator car or cabin during such inspection runs and operates the elevator at a relatively slow speed from this location. Such inspection runs represent a normal operating mode for which an elevator brake is designed.

It can easily occur that the elevator brake malfunctions and one or more brake shoe(s) is/are in contact with the brake drum while the elevator cabin is in motion. Elevator drives, in particular those with AC power controllers or frequency converters, are usually sufficiently powerful for moving the elevator cabin at the predetermined rated speed while the elevator brake is completely engaged. Although the passengers sense no impairment of any kind during this mode of operating with the engaged brake, an intense temperature increase occurs extremely quickly in the brake linings, with the result that the brake linings are subjected to correspondingly intense wear. This can destroy or completely wear out or harden/vitrify the brake linings within a few travel cycles and render the brake system non-functional. In the worst-case scenario, the brake is no longer able to hold the cabin in place at a stop. It may even occur that the cabin moves away from the stopping point while the elevator doors are open. This is extremely dangerous for the elevator passengers, and has led to various proposals for elevator brake monitoring devices. Elevator brakes with a temperature monitoring arrangement for detecting this type of condition have also been proposed.

An elevator brake of this type with a brake monitoring arrangement is, for example, described in U.S. Pat. No. 6,095,289 A. The sensors of this brake monitoring arrangement are situated in recesses in the brake shoes that extend into the brake shoe, to a predetermined depth, in the form of blind holes from the contact surface between the brake shoe and the brake lining. This means that old brake linings need to be removed when retrofitting an existing elevator brake, and that recesses need to be produced in the brake shoe in order to install the sensors. After this process is completed, new brake linings need to be applied. This arrangement also contains an ambient temperature sensor that is also arranged in a brake shoe, but spaced apart from the brake lining by a certain distance. This means that the temperature sensors essentially measure the temperature of the brake shoe in the vicinity of the brake lining and at a location that is spaced apart from this measuring point by a relatively short distance.

U.S. Pat. No. 5,419,415 A also describes an elevator brake with a brake monitoring arrangement in which a sensor is situated in a through-opening in the brake shoes and projects into the brake lining by a certain distance. The sensor itself is arranged in a carrier material, for example, of artificial resin, and separated from the surface of the artificial resin material on all sides to such a degree that it is essentially unable to measure only the temperature of the brake lining. On the contrary, the brake shoe significantly influences the temperature measurement of the sensor.

It was determined that two aspects are particularly important for the commercial success of such brake monitoring circuits. First, it must be possible to easily and inexpensively retrofit existing elevator systems at the installation site without requiring a replacement of the brake linings. Second, it must be possible to rapidly and accurately determine the temperature difference between the brake lining and the ambient temperature in order to reliably and rapidly detect an undesirable frictional contact between the brake lining and the brake drum, and to prevent the faulty triggering of the elevator brake during a desired frictional contact, for example, during inspection runs while the brake is intentionally engaged to a certain degree.

The demand for retrofitting existing elevator systems with brake monitoring arrangements of this type is, in principle, very high. However, the use of such brake monitoring arrangements is not prescribed by law. Consequently, economic considerations frequently play an important role when deciding whether to retrofit or not. If a brake failure of the previously described type does not occur, brake linings generally have a very long service life. The replacement of brake linings is quite complicated and costly. This is the reason that operators of elevator systems utilize the brake linings of the brake system as long as possible. Retrofitting options which required a replacement of the brake linings as part of the installation of the brake monitoring arrangement and, in particular, brake lining temperature sensors, have consequently not been very popular so far for economic reasons. From an economic standpoint, it would be very desirable to provide a retrofitting option that does not require a replacement of the brake linings.

The brake monitoring arrangement and the sensors need to rapidly and sensitively respond to a temperature increase in the brake linings in order to determine whether a malfunction has actually occurred or an inspection run is being performed. A rapid and sensitive response is also required for detecting a malfunction before excessive wear of the brake linings occurs. The brake monitoring arrangement is typically connected to the elevator control in such a way that, once a malfunction is detected, the elevator is able to continue to the next stop and the passengers can exit the cabin. Elevator service personnel subsequently repair the malfunction, and the elevator can be used normally once again. If a malfunction can be detected sufficiently quickly, the brake linings are subjected to only relatively slight wear such that the same brake linings can still be used. This is another reason why it is desirable to rapidly detect a malfunction. Numerous elevator systems still contain asbestos brake linings, excessive abrasion of which can pose a significant health risk to the passengers and the elevator service personnel within a very short time. The above-mentioned objectives can only be attained if the sensors respond as fast as possible. However, it must also be possible to operate the elevator during inspection runs without triggering a malfunction response. During inspection runs, the elevator moves at a slow speed of no more than 0.63 m/sec. Inspection runs are usually performed during the initial calibration phase and the retrofitting phase, during which the brake serves as a deceleration brake. The brake monitoring arrangement cannot trigger a malfunction response during such inspection runs. There are also certain machines that generate so much internal heat that even the brake linings are heated via the drive shaft. A malfunction response cannot be triggered in such instances either.

Consequently, the present invention is based on the objective of making available an elevator brake of the previously described type that is inexpensive and that makes it possible to cost-efficiently retrofit existing systems without requiring a replacement of the brake linings; the elevator brake according to the invention should also be sufficiently sensitive for rapidly and reliably detecting malfunctions.

According to the invention, this objective is attained due to the fact that the brake lining temperature sensor has a generally cylindrical shape and is temperature-sensitive on its front end, to the fact that the brake lining temperature sensor is arranged in a through hole in the brake shoe in such a way that its temperature-sensitive front end is generally level with the contact surface between the brake shoe and the brake lining, and to the fact that the brake lining temperature sensor is insulated from the inner wall of the through hole. It is preferred to arrange one or more brake lining temperature sensors in each brake shoe.

The design of the brake lining temperature sensor and the arrangement of a through hole in the brake shoe also allow a simple and cost-efficient subsequent installation. The through hole in the brake shoe can be produced relatively easily at the installation site with a simple drill, e.g., with a bit stop. The essentially cylindrical shape of the temperature sensor makes it possible to install the temperature sensor in this opening easily. A replacement of the brake lining is not required as part of the retrofitting process. The temperature sensitivity of the temperature sensor on its front end, its essentially level arrangement with the contact surface between the brake shoe and the brake lining, and its insulation from the brake shoe ensure that the brake shoe temperature sensor essentially measures only the temperature of the brake lining. In temperature sensors of brake monitoring arrangements according to the prior art that are arranged on the brake shoes, the measurement values of the temperature sensors are significantly influenced by the cooling volume of the brake shoes. This has resulted in a very sluggish measurement. Sufficiently reliable information on the temperature of the brake lining can only be obtained by eliminating the possible interfering influences of the brake shoe on the temperature measurement by means of the above-mentioned insulation. This information makes it possible to ensure a reliable and sufficiently sensitive response of the brake monitoring arrangement.

According to the invention, existing elevator systems can be easily and inexpensively retrofitted with a brake monitoring arrangement by means of a method that comprises the following:

Method for retrofitting an elevator system with a brake monitoring arrangement, comprising the following steps:
(a) drilling a through hole in the brake shoe that ends at the brake lining;
(b) installing a brake lining temperature sensor with a temperature-sensitive front end into the through hole in such a way that the brake lining temperature sensor is insulated from the inner wall of the through hole;
(c) installing an ambient temperature sensor in the elevator shaft;
(d) installing a brake monitoring circuit in the elevator system;
(e) connecting the temperature sensors to the brake monitoring circuit such that information can be exchanged, and
(f) connecting the brake monitoring circuit to the elevator control.

The brake lining temperature sensor is preferably provided with a laterally insulated housing. The housing insulation can simultaneously serve as the insulation from the inner wall of the through hole in the brake shoe. Naturally, it would also be possible to provide additional insulation between the sensor and the inner wall. Certain temperature sensors have a cylindrical shape and have a ceramic body, with a corresponding temperature-sensitive point being arranged only on the front end of the cylindrical temperature sensor. This type of sensor is particularly preferred.

Insulation is preferably arranged between the inner wall of the through hole and the brake lining temperature sensor. This is particularly advantageous in instances in which the temperature sensors have a housing that essentially consists entirely of metal. The insulation can, for example, consist of a plastic material.

The brake lining temperature sensor is preferably force-fit in place in the through hole. For example, the insulation may serve to clamp the temperature sensor in place. It would be conceivable to provide a bushing that fits relatively tightly in the through hole and provides a relatively rigid seat for the sensor. It is advantageous that the sensor be clamped in place because a defective sensor can be relatively easily replaced and, when replacing the brake linings, it is also quite simple to once again bring the sensor in optimal contact with the surface of the brake lining. It is advantageous for the temperature-sensitive front region of the sensor to adjoin the brake lining. However, it would also be conceivable to provide a certain air gap between the brake lining and the sensor. The air in this intermediate space is heated relatively quickly by the brake lining, with the temperature being measured by the sensor. It may be practical to arrange a thermally conductive material, e.g., a heat conducting paste, between the brake lining and the sensor in order to ensure the fastest possible thermal conduction between the brake lining and the sensor.

It is preferred to secure the brake lining temperature sensor in the through hole with the aid of an adhesive. The adhesive can simultaneously serve as insulation. The adhesive provides the advantage of reliably holding the brake lining temperature sensor in position such that it cannot slide out of the through hole. It would also be conceivable to additionally secure a temperature sensor that is already force-fit in place with the aid of an adhesive, or alternatively to provide a clamping arrangement for the temperature sensor that allows movement of the sensor in the direction of the brake lining, but prevents the sensor from moving away from the brake lining-e.g., by means of a catch arrangement. For example, it may be practical to bond the bushing for securing the temperature sensor in the through hole in the through hole, with the sensor merely being inserted into the bushing.

The brake monitoring circuit is preferably realized in such a way that it is able to monitor the functions of the temperature sensors. Typical defects of temperature sensors are short circuits or line interruptions. The circuit can be designed in such a way that it continuously or intermittently detects a short circuit or line interruption in the temperature sensor, for example, by means of a resistance measurement. A change in the resistance may also indicate a defect in the temperature sensor. It is practical for the brake monitoring circuit to display such anomalies. These anomalies can, for example, be transmitted to a remote monitoring center. If several brake lining temperature sensors are provided, an individual sensor can be deactivated if it is determined that a malfunction of this sensor has occurred, with said sensor subsequently being repaired as part of periodic maintenance work.

The brake monitoring circuit is preferably realized in such a way that it opens a switch in a safety circuit when a predetermined difference in the temperatures measured by the ambient temperature sensor and the brake lining temperature sensor is exceeded. It is preferred to open the switch and the safety circuit because safety circuits in elevator systems are typically designed such that the opening of a switch in the circuit causes an error message to be displayed. This switch may consist of a switch in the safety chain of the elevator. However, if the switch is arranged in the safety chain of the elevator, the elevator is immediately stopped when a malfunction occurs, i.e., the movement of the elevator does not continue in a controlled fashion to a stop, but rather is abruptly interrupted. The passengers are unable to exit the cabin until the elevator service personnel arrives. Consequently, it is preferred to forward the signal of the brake monitoring circuit to the safety check input of the printed circuit board of the elevator control. An inquiry of these printed circuit board inputs typically takes place before the beginning of each elevator movement such that the elevator is able to complete its movement if such an error signal is generated. However, the elevator is subsequently rendered inoperative. A differential temperature provides the advantage that temperature increases of the brake lining, e.g., during inspection runs, do not lead to the elevator being switched off. It was determined during test runs that temperature differences of approximately 25° K. referred to the ambient temperature occur during typical inspection runs. This means that the trigger difference should be greater than 25° K. The invention proposes a trigger difference in excess of 40° K., preferably in excess of 50° K., in particular, in excess of 60° K. Such trigger differences provide a sufficient safety factor. Tests on a typical elevator brake showed that a malfunction led to a temperature increase of 110° C. (absolute) within several seconds (ambient temperature 20° C.).

The brake monitoring circuit preferably contains a bistable element that changes over from a first state to a second state when a predetermined difference between the temperatures measured by the ambient temperature sensor and the brake lining temperature sensor is exceeded. The switch in the safety circuit is preferably opened in the second state. The utilization of a bistable element provides the advantage that the switch in the safety circuit remains open and switched to the second state as the brake lining temperature decreases. This ensures that the brake monitoring arrangement can only be reset by the elevator service personnel. Normally, the elevator service personnel only reset the brake monitoring arrangement after the defect is repaired.

The invention is described below with reference to one embodiment that is illustrated in the figures. The figures show:

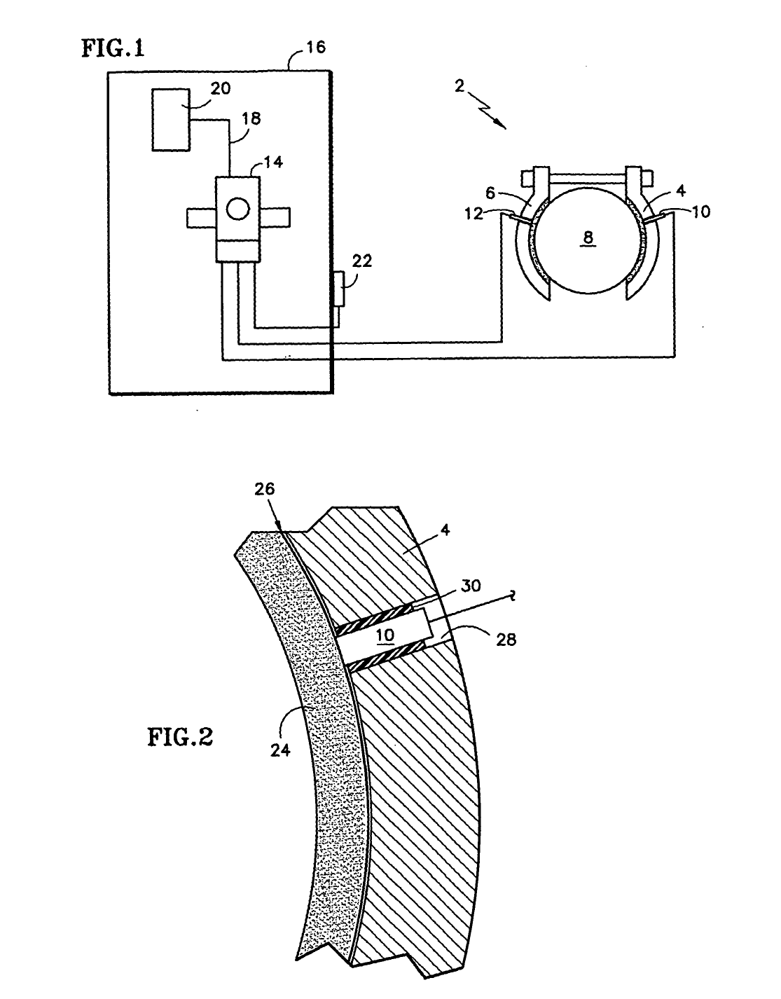

FIG. 1, a schematic representation of an elevator brake with a brake monitoring arrangement;

FIG. 2, a detail of an elevator brake according to the invention, and

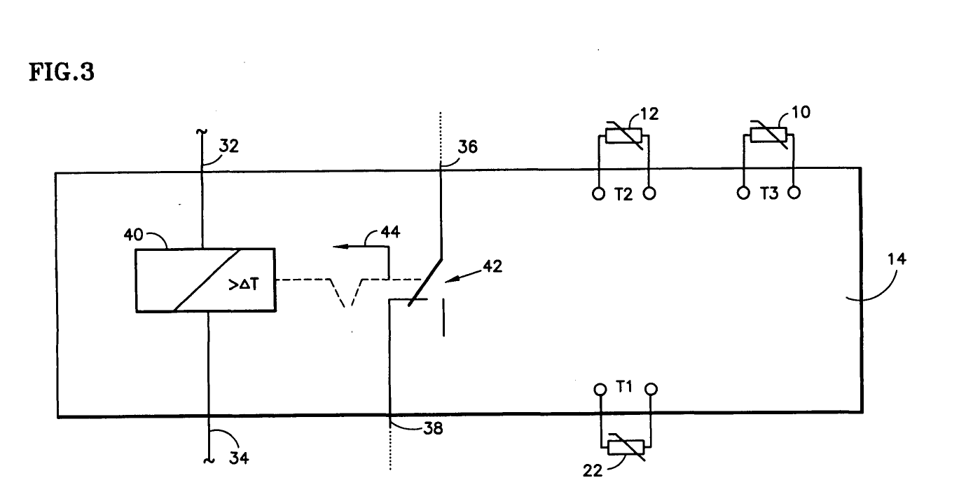

FIG. 3, a schematic representation of the brake monitoring circuit.

FIG. 1 shows an elevator brake 2 that comprises, for example, brake shoes or brake lever arms 4 and 6 that are prestressed in the direction of the engaged position by means of a (not-shown) spring arrangement. One respective brake lining is fixed on the brake shoes 4 and 6, for example, by means of bonding and/or riveting, etc. In the engaged state, the braking surfaces of the brake linings come in contact with the outer circumference of a brake drum 8. A (not-shown) electromagnetic actuator may be provided for ventilating the brake.

The elevator brake 2 is typically utilized for holding the cabin in position during a stop at an entry/exit point. If the cabin is subjected to a load that corresponds to half of the maximum capacity, the cabin and the counterweight are usually at equilibrium. This means that the braking forces to be generated by the brake usually are correspondingly low. The drive unit of the elevator usually is so powerful that it is able to relatively easily move the cabin in the elevator shaft while the brake 2 is engaged. However, the temperature increase occurring in the brake linings usually results in intense wear of the brake linings. This can lead to a brake failure within a very short period of time. Consequently, it is advantageous to monitor the function of the brake. Beginning at a certain state of wear, the brake is no longer able to hold the cabin in position at a stop such that the cabin may uncontrollably shift. In most instances, such an uncontrolled shift occurs while the cabin door and the shaft door are open. Consequently, the risk of injuries for passengers situated in the cabin and passengers standing at the opened shaft door is correspondingly high. If the brake linings are subjected to normal wear, it is relatively simple to determine the state of wear of the brake linings in a timely fashion as part of periodic maintenance work or inspections and, if so required, to exchange the brake linings. The situation becomes problematic when intense wear of the brake linings occurs within a very short period of time due to a brake failure. In order to prevent such excessive wear, the brake 2 contains a monitoring arrangement that essentially consists of brake lining temperature sensors 10 and 12 and a brake monitoring circuit 14 that is able to generate and deliver a corresponding warning signal, for example, to the elevator control.

In the embodiment shown in FIG. 1, the brake monitoring circuit 14 is accommodated in the switch gear cabinet 16 of the elevator control, with a signal output line 18 being connected to the printed circuit card input 20 of the elevator control. This input consists of an input to which safety-relevant components of the elevator system are connected and which is checked by the elevator control before the beginning of each elevator movement. If it is determined during this so-called safety check that one of the connected component is not functional, the elevator system is rendered inoperative and can no longer be used. This printed circuit board input differs from the so-called safety chain of the elevator system due to the fact that such a check only takes place before the beginning of an elevator movement, and that the elevator is rendered inoperative at a time at which the passengers are able to exit the cabin. For example, other safety-relevant components are connected to the safety chain of the elevator. The safety chain is wired in such a way that, if one of the components connected thereto malfunctions, the safety chain is interrupted and the elevator is immediately rendered inoperative. This means that the elevator does not complete its movement to the intended stop. The passengers situated in the cabin can only exit the cabin after correspondingly trained personnel arrive. Naturally, it would be conceivable to couple the brake monitoring arrangement according to the invention to the safety chain; however, it is preferred to connect the brake monitoring arrangement to the printed circuit board input for apparent reasons. The brake monitoring circuit 14 has three inputs for the data of the brake lining temperature sensors 10, 12 and for the temperature data of an ambient temperature sensor 22. The connections for the power supply of the brake monitoring circuit 14 are not shown.

The ambient temperature sensor 22 is arranged outside the switchgear cabinet 16. It would also be possible to integrate the ambient temperature sensor 22 into the brake monitoring circuit 14. However, this is disadvantageous because the temperatures in the switchgear cabinet can significantly exceed the ambient temperatures in the elevator shaft and in the engine room. For example, temperatures up to 55° C. were measured in the switchgear cabinet. The ambient temperature sensor 22 may be arranged in the elevator shaft or in the engine room.

FIG. 2 shows part of a brake shoe 4 with a brake lining 24 attached to it. The brake linings 24 can, for example, be fixed on the brake shoes 4 by means of bonding or riveting. The brake shoes 4 and the brake linings 24 adjoin one another at a contact surface 26. In FIG. 2, the contact surface 26 is illustrated in the form of a gap. However, this gap is actually nonexistent or extremely small.

FIG. 2 also shows a brake lining temperature sensor that is arranged in a through hole 28 in the brake shoe 4. One can ascertain that the front end of the brake lining temperature sensor 10 adjoins the contact surface 26 between the brake lining 24 and the brake shoe 4. It is particularly preferred that the brake lining temperature sensor 10 has a temperature-sensitive front end such that it essentially measures the temperature at this location of the brake lining. It is advantageous to arrange the brake lining temperature sensor in the central region of the brake lining in order to essentially eliminate cooling effects as they may occur on the edge of the brake lining 24. The brake lining temperature sensor 10 has an essentially cylindrical shape and a relatively small diameter of less than 5 mm, preferably less than 3 mm, in particular, 2 mm or less, namely because the weakening of the brake shoes 4 caused by the through holes 28 decreases proportionally with the diameter of the brake lining temperature sensor. It is particularly advantageous that the brake lining temperature sensor has such a diameter that it can be easily fitted into the typical through holes provided for the rivets used for fixing the brake lining on the brake shoe.

Insulation 30 is provided between the inner wall of the through hole 28 and the sensor. This insulation 30 is, in particular, required if the sensor 10 is not insulated in this region. In FIG. 2, the insulation 30 consists of a plug-in sleeve of a heat-resistant, heat-insulating plastic material. The plug-in sleeve is arranged in the through hole 28. The temperature sensor 10 is inserted into the sleeve. The sleeve itself can be fixed in the through hole 28 with an adhesive. However, it can also be held therein solely by the clamping effect. The clamping effect may be increased by slightly tapering the opening in the sleeve, into which the temperature sensor 10 is inserted, toward the front end, i.e., toward the brake lining 24. This increases the clamping effect similar to a wedge when the temperature sensor 10 is inserted into the plug-in sleeve. The temperature sensor 10 and/or the plug-in sleeve or insulation 30 can be secured with a safety lacquer or the like after the installation.

FIG. 3 shows the circuit arrangement of the brake monitoring system schematically. This figure shows the brake lining temperature sensors 10 and 12 and the ambient temperature sensor 22 that is connected to the brake monitoring circuit 14. In order to realize the power supply, the brake monitoring circuit 14 is connected to a high potential at 32 and to a low potential at 34. The voltage is preferably tapped at the safety chain. This ensures that the safety chain cannot be bypassed by the brake monitoring circuit 14. The brake monitoring circuit 14 is connected to the printed circuit board input 20 of the elevator control at 36 and 38 as described above. The reference symbol 40 identifies a bistable switching element with corresponding comparison electronics. The bistable switching element may, for example, consist of a bistable relay. The element 40 monitors the function of the temperature sensors and generates a warning signal if a temperature sensor fails. If a certain threshold value of the difference between the brake lining temperature and the ambient temperature is exceeded, the element 40 or the bistable element, respectively, switches from one bistable state to a second bistable state and opens the brake monitoring contact 42. In the position of the brake monitoring contact 42 shown in this figure, the contact is closed, i.e., the brake monitoring circuit delivers a signal indicating the proper function of the brake to the printed circuit board input. If the bistable element changes from one state to the other state due to the temperature threshold being exceeded, the brake monitoring contact 42 opens and the connection between 36 and 38 is interrupted.

If the brake monitoring circuit 14 has been triggered, the brake monitoring circuit 14 can be reset again to its initial state by the elevator service personnel after the defect is repaired, e.g., by means of a reset button. This is schematically illustrated in FIG. 3 in the form of a part 44. The threshold value of the temperature difference preferably can be adjusted on the brake monitoring circuit 14. Alternatively, a fixed threshold value is preset.

It would be possible to eliminate a separate ambient temperature sensor 22. However, this would make it necessary to monitor the temperature increase with a brake lining temperature sensor 10, 12. If the brake fails, a temperature increase occurs which corresponds to the previously described threshold value of the difference between the temperatures measured by the brake lining temperature sensor 10 and the ambient temperature sensor 22, namely within a relatively short time that generally lies between 10-30 seconds, but usually does not exceed 100 sec. The brake monitoring circuit may be designed in such a way that it is able to detect such a temperature increase with the aid of a brake lining sensor 10, 12. For this purpose, the brake monitoring circuit may, for example, contain a storage device, with the actual temperature value measured by a brake lining temperature sensor 10, 12 being compared with a temperature value of the same brake lining temperature sensor which was previously stored in the storage device. A brake lining temperature sensor that is utilized in this fashion can simultaneously serve as an “ambient temperature sensor.”

Preferred embodiments of the subject invention have been described. One of ordinary skill in the art would recognize that modifications can be made without departing from the scope of the invention, which is to be determined by reference to the following claims.

1. Elevator brake (2) comprising a brake shoe (4, 6) and a brake lining (24) attached thereto, at least one brake lining temperature sensor (10, 12) arranged in the brake shoe (4, 6), at least one ambient temperature sensor (22), and a brake monitoring circuit (14) that is connected to and receives information from the temperature sensors (10, 12, 22), characterized by the fact that the brake lining temperature sensor (10, 12) has a temperature-sensitive front end, the brake lining temperature sensor (10, 12) is arranged in a through hole (28) in the brake shoe (4, 6) in such a way that its temperature-sensitive front end is in thermal communication with the brake lining (24) at a location adjoining the contact surface (26) between the brake shoe (4, 6) and the brake lining (24), and the brake lining temperature sensor (10, 12) is thermally insulated from the inner wall of the through hole (28).

2. Elevator brake (2) according to claim 1, characterized by the fact that the brake lining temperature sensor (10, 12) is provided with a laterally insulated housing.

3. Elevator brake (2) according to claim 1, characterized by the fact that insulation (30) is arranged between the inner wall of the through hole (28) and the brake lining temperature sensor (10, 12).

4. Elevator brake (2) according to claims 1, characterized by the fact that the brake lining temperature sensor (10, 12) is clamped in place in the through hole (28).

5. Elevator brake (2) according to claims 1, characterized by the fact that the brake lining temperature sensor (10, 12) is secured in the through hole (28) with an adhesive.

6. Elevator brake (2) according to claims 1, characterized by the fact that a plug-in sleeve, into which the brake lining temperature sensor (10, 12) is inserted, is arranged in the through hole (28).

7. Elevator brake (2) according to claims 1, characterized by the fact that the brake monitoring circuit (14) is realized in such a way that it can monitor the function of the temperature sensors (10, 12, 22).

8. Elevator brake (2) according to claims 1, characterized by the fact that the brake monitoring circuit (14) is realized in such a way that it opens a switch in a safety circuit if a predetermined difference between the temperatures measured by the ambient temperature sensor (22) and the brake lining temperature sensor (10, 12) is exceeded.

9. Elevator brake (2) according to claims 1, characterized by the fact that the brake monitoring circuit (14) contains a bistable element that changes over from a first state to a second state if a predetermined difference between the temperatures measured by the ambient temperature sensor (22) and the brake lining temperature sensor (10, 12) is exceeded.

10. Method for retrofitting an elevator system (2) with a brake monitoring arrangement, comprising the following steps:
(a) providing a through hole (28) that ends at the brake lining (24) into the brake shoe (4, 6);
(b) installing a brake lining temperature sensor with a temperature-sensitive front end into the through hole (28) in such a way that the brake lining temperature sensor (10, 12) is thermally insulated from the inner wall of the through hole (28);
(c) installing an ambient temperature sensor in the elevator shaft;
(d) installing a brake monitoring circuit (14) in the elevator system;
(e) connecting the temperature sensors to the brake monitoring circuit (14) such that information can be exchanged, and
(f) connecting the brake monitoring circuit (14) to the elevator control.
